(19) United States
(12) Patent Application Publication
(10) Pub. No.: US 2007/0263908 A1
(43) Pub. Date: Nov. 15, 2007

(54) Iris Authentication Device

(75) Inventor: Shinichi Tsukahara, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/718,659

(22) PCT Filed: Nov. 10, 2005
(86) PCT No.: PCT/JP05/21065

§ 371 Date: May 4, 2007

(30) Foreign Application Priority Data
Nov. 11, 2004 (JP) JP 2004-327443

(51) Int. Cl. G06K 9/00

(52) U.S. Cl. 382/117

(57) ABSTRACT

An iris verification device includes: an imaging section for taking an image of an eye of a user; a first saccade indicator for pointing a sight line of the user; a second saccade indicator, which is placed apart from the first saccade indicator, for pointing the sight line of the user; a sight line detecting section for detecting the sight line of the user from the image taken at the imaging section; an iris image sampling section for sampling an iris image from the image taken at the imaging section; a verification section for performing an iris verification act based on the iris image sampled at the iris image sampling section. Variation of the sight line of the user accompanied by the lighting-up of the first saccade indicator or the second saccade indicator is detected as biological reaction by using the sight line detecting section.

### TECHNICAL FIELD

The present invention relates to an iris verification device which can prevent an unfair verification act such as impersonation.

### BACKGROUND ART

In a security system or the like, a method of verification using a pattern of a personal iris is disclosed, for example, in Japanese Translation of PCT Publication H8-504979 or Unexamined Japanese Patent Publication No. 2000-23946. The verification method using an iris has an advantage over a fingerprinting method, because it can be operated in noncontact for the iris and performed by taking an image with a camera from a remote position. Therefore, it is expected to be widespread in the future.

However, an unfair verification act is enabled by copying an iris image of others to a photograph, an artificial eye or the like and using it in iris verification. Accordingly, a method for preventing these unfair verification acts is proposed. As the typical method, for example, a method using biological reaction that pupil is contracted depending on intensity of light is disclosed in Unexamined Japanese Patent Publication No. 2003-30659.

However, a certain time is necessary for causing the reaction of the pupil, and more particularly, several tens of seconds are necessary for dilating the pupil. Therefore, in a case of detecting pupillary reaction repeatedly, it has taken a long time.

### SUMMARY OF THE INVENTION

In view of situations discussed above, the present invention is directed to provide an iris verification device which can detect biological reaction in a short time and prevent unfair verification acts such as impersonation.

The iris verification device of the present invention includes the following elements:

an imaging section for taking an image of an eye of a user;

a first saccade indicator for fixing a sight line of the user by lighting-up;

a second saccade indicator, which is placed apart from the first saccade indicator, for moving the sight line of the user by lighting-up;

a sight line detecting section for detecting the sight line of the user from the image taken at the imaging section;

an iris image sampling section for sampling an iris image from the image taken at the imaging section; and

a verification section for performing iris verification based on the iris image sampled at the iris image sampling section.

The sight line detecting section detects movement of the sight line of the user, which is accompanied by the lighting-up of the second saccade indicator.

This structure discussed above can detect the biological reaction in a short time and prevent unfair verification acts such as impersonation by detecting the movement of an eye point.

In addition, another iris verification device of the present invention includes the following elements:

a first imaging section for taking an image of an eye of a user;

a first saccade indicator, which is placed adjacent to the first imaging section, for fixing a sight line of the user;

a second imaging section, which is placed apart from the first imaging section, for taking an image of the eye of the user;

a second saccade indicator, which is placed adjacent to the second imaging section, for moving the sight line of the user;

a sight line detecting section for detecting the sight line of the user from the image taken at least at one of the first imaging section and the second imaging section;

an iris image sampling section for sampling an iris image from the image taken at least at one of the first imaging section and the second imaging section; and

a verification section for performing iris verification based on the iris image sampled at the iris image sampling section.

The sight line detecting section detects movement of the sight line of the user, which is accompanied by lighting-out of the first saccade indicator and lighting-up of the second saccade indicator.

This structure discussed above can also detect the biological reaction in a short time and prevent unfair verification acts such as impersonation by detecting the movement of an eye point.

Furthermore, the iris verification device of the present invention may include a saccade display, which is placed between the first saccade indicator and the second saccade indicator, for displaying a password, and a password input section for inputting the password displayed at the saccade display, and a controller for determining whether the password input from the password input section is correct or not.

This structure discussed above can prevent unfair verification acts such as impersonation further securely by making the user read and input the password in the movement of the eye point.

As discussed above, the present invention can provide the iris verification device which can prevent unfair verification acts such as impersonation.

### BRIEF DESCRIPTION OF THE DRAWINGS

FIGS. 1A and 1B are schematic diagrams of iris verification devices in accordance with a first exemplary embodiment of the present invention.

FIG. 2 is a circuit block diagram of the iris verification device in accordance with the first exemplary embodiment of the present invention.

FIGS. 3A and 3B show a method for detecting a sight line in accordance with the first exemplary embodiment and a second exemplary embodiment of the present invention.

FIGS. 4A through 4G show a method for indicating a password with a saccade display in accordance with the first exemplary embodiment and the second exemplary embodiment of the present invention.

FIG. 5 is a timing chart indicating the saccade display in accordance with the first exemplary embodiment and the second exemplary embodiment of the present invention.

FIG. 6 is a flow chart showing operation of the iris verification device in accordance with the first exemplary embodiment of the present invention.

FIGS. 7A and 7B are schematic diagrams of iris verification devices in accordance with the second exemplary embodiment of the present invention.

FIG. 8 is a circuit block diagram of the iris verification device in accordance with the second exemplary embodiment of the present invention.

FIG. 9 is a flow chart showing operation of the iris verification device in accordance with the second exemplary embodiment of the present invention.

### PREFERRED EMBODIMENTS FOR CARRYING OUT THE INVENTION

The present invention utilizes saccade phenomenon which is fast biological reaction for preventing an unfair verification act such as impersonation (for example, see “a proposal of a new method for presenting information using saccade” Journal of Virtual Reality Society of Japan Vol. 6, No. 2, 2001). The exemplary embodiments of the present invention are described hereinafter with reference to the drawings.

### First Exemplary Embodiment

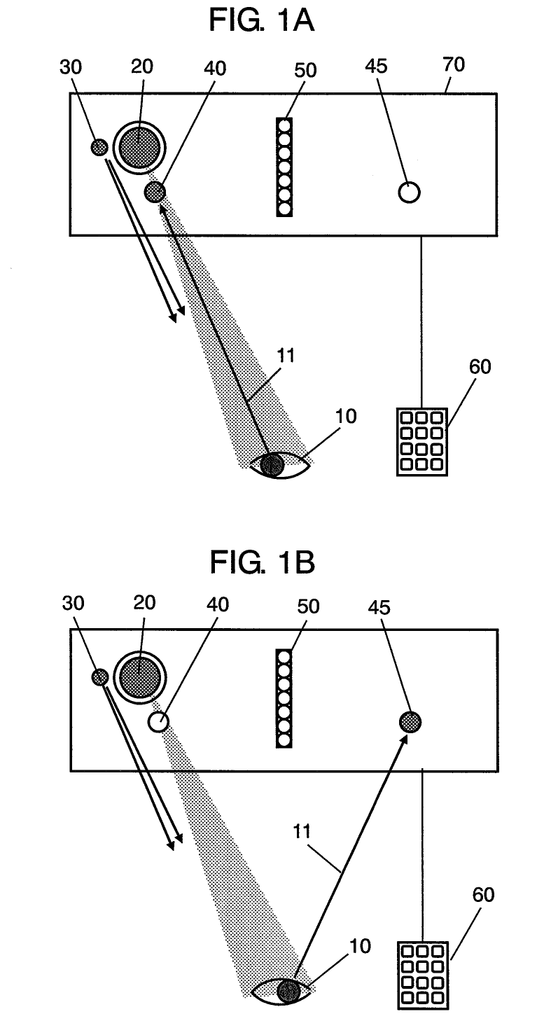

FIGS. 1A and 1B are schematic diagrams of iris verification devices in accordance with a first exemplary embodiment of the present invention. Camera 20 takes an image of eye 10 of a user. Infrared emitting diode 30 for emitting near-infrared light to illuminate eye 10 is placed near camera 20. Furthermore, first saccade indicator 40 for assisting eye 10 of the user to gaze into camera 20 is placed near camera 20. For example, a visible-light emitting diode for emitting visible light can be used as first saccade indicator 40. Second saccade indicator 45 is placed apart from first saccade indicator 40. In the present embodiment, a distance between eye 10 and camera 20 is set at approximately 35 cm, and an interval between first saccade indicator 40 and second saccade indicator 45 is set at approximately 6.1 cm in such a manner that an angle of saccade becomes approximately 10°.

Saccade display 50 for indicating a password is placed between first saccade indicator 40 and the second saccade indicator (for example, see the above-mentioned Journal “a proposal of a new method for presenting information by using saccade” concerning the saccade display). As shown in FIGS. 1A and 1B, seven visible-light emitting diodes arranged in a line are used here. The user can input the password displayed at saccade display 50 by using password input means 60 which is a password input section such as a keyboard. Bellow mentioned signal processing section 170, controller 180, verification section 190 and the like are placed at housing 70.

FIG. 1A shows a state of making sight line 11 of eye 10 fixed to first saccade indicator 40 by lighting-up first saccade indicator 40. FIG. 1B shows a state of making sight line 11 move to second saccade indicator 45 by lighting-out first saccade indicator 40 and lighting-up second saccade indicator 45.

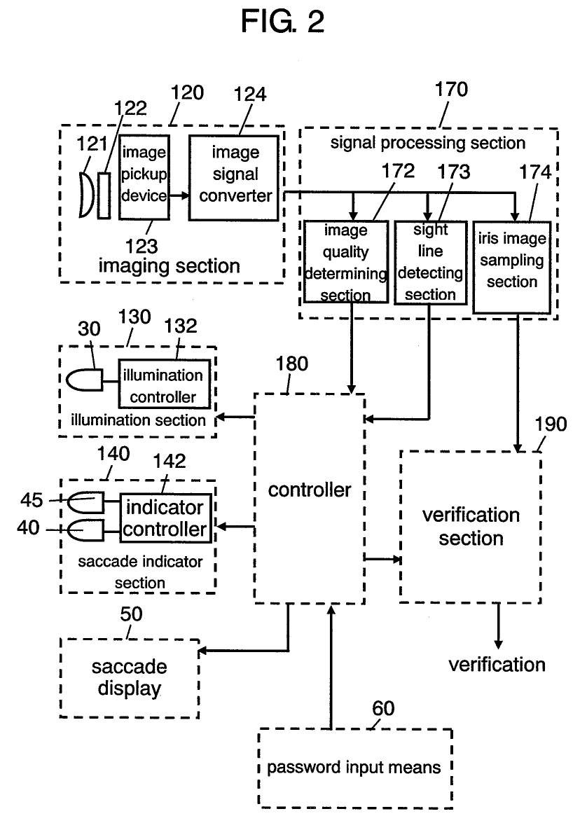

FIG. 2 is a circuit block diagram of the iris verification device in accordance with the first exemplary embodiment of the present invention. Imaging section 120 forming camera 20 includes imaging lens 121 for forming an image of the eye, filter 122 for transmitting wavelengths of near-infrared light or the like within a certain range, image pickup device 123 such as a CCD for converting transmitted light into an electric signal, and image signal converter 124 for processing an electric signal output from image pickup device 123.

An image signal output from image signal converter 124 is sent to signal processing section 170. Signal processing section 170 includes image quality determining section 172 for determining contrast, brightness and the like of the image signal, sight line detecting section 173 for detecting the sight line from the image signal, and iris image sampling section 174 for sampling the iris image from the image. Signals from image quality determining section 172 and sight line detecting section 173 are sent to controller 180, and a signal from iris image sampling section 174 is sent to verification section 190.

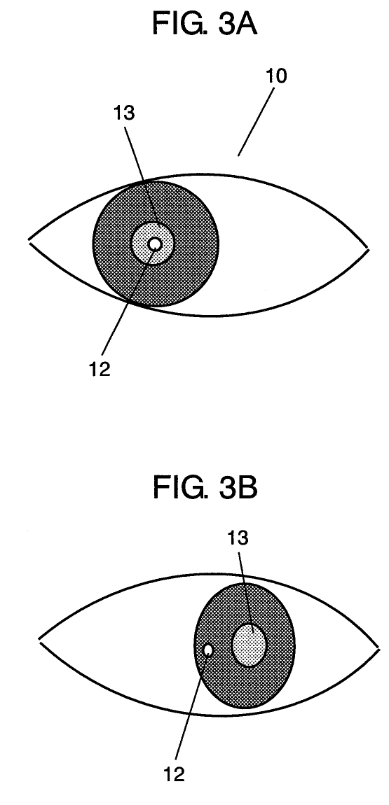

FIGS. 3A and 3B show a method for detecting the sight line. When eye 10 is irradiated with light from infrared emitting diode 30 or saccade indicator 40, the light is reflected at a cornea and corneal reflected light 12 is generated. A direction of the sight line can be determined by detecting a difference between corneal reflected light 12 and a center position of pupil 13. When corneal reflected light 12 substantially corresponds to the center position of pupil 13 as shown in FIG. 3A, sight line detecting section 173 determines that sight line 11 points toward camera 20. On the other hand, when corneal reflected light 12 is apart from the center position of pupil 13 as shown in FIG. 3B, sight line detecting section 173 determines that sight line 11 does not point toward camera 20.

Illumination section 130 includes infrared emitting diode 30 for emitting near-infrared light which irradiates eye 10 of the user, and illumination controller 132 for controlling light amounts of infrared emitting diode 30. Saccade indicator section 140 includes first saccade indicator 40 for emitting visible light, second saccade indicator 45, and indicator controller 142 for controlling light amounts of the saccade indicator.

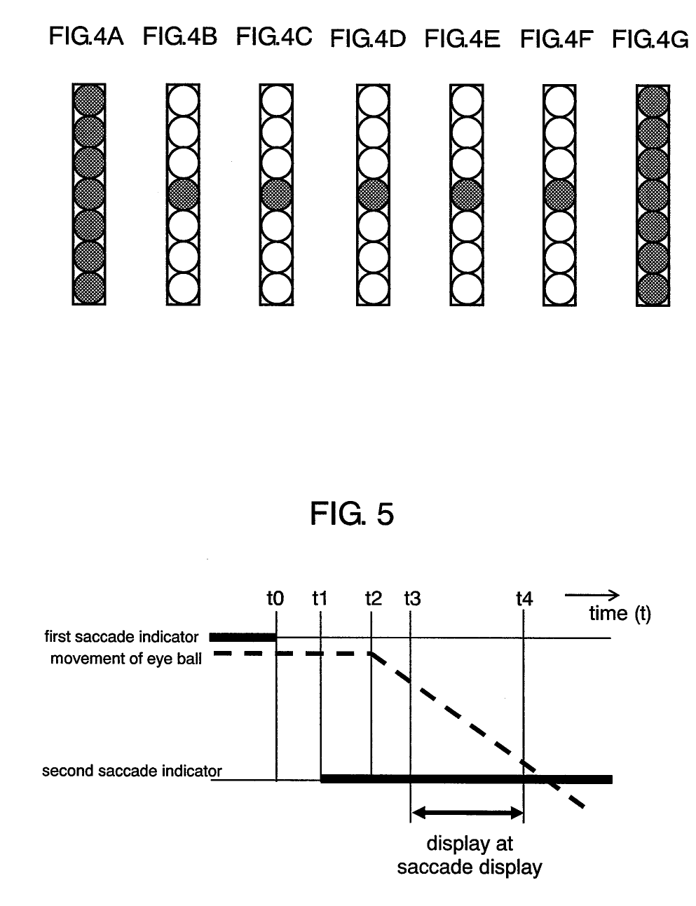

Saccade display 50 has a function of displaying the password. According to the present embodiment, saccade display 50 has a structure where seven visible-light emitting diodes are arranged in a line as shown in FIGS. 1A and 1B. FIGS. 4A through 4G show a method for indicating a password “H” as an example. First, fix sight line 11 of the user to camera 20 by lighting up first saccade indicator 40. Then, light up second saccade indicator 45, so that sight line 11 is moved to second saccade indicator 45. Meanwhile, light up all seven visible-light emitting diodes as shown in FIG. 4A. Next, light up only one central visible-light emitting diode as shown in FIG. 4B. Then, light up as shown in FIG. 4C, FIG. 4D, FIG. 4E, FIG. 4F, and FIG. 4G in this order. Thus, while an eyeball of the user moves, changing of the image of saccade display 50 remains as an afterimage, so that an image of “H is displayed for the user. In this way, the password can be displayed by using saccade display 50. According to the present embodiment, the example showing simple letter “H” is demonstrated to illustrate its principle easily. However, more complicated letter or several-digit password can be displayed by increasing the number of visible-light emitting diodes of saccade display 50 or the number of lines thereof. According to the present embodiment, controller 180 gives different passwords every time, and allows saccade display 50 to display.

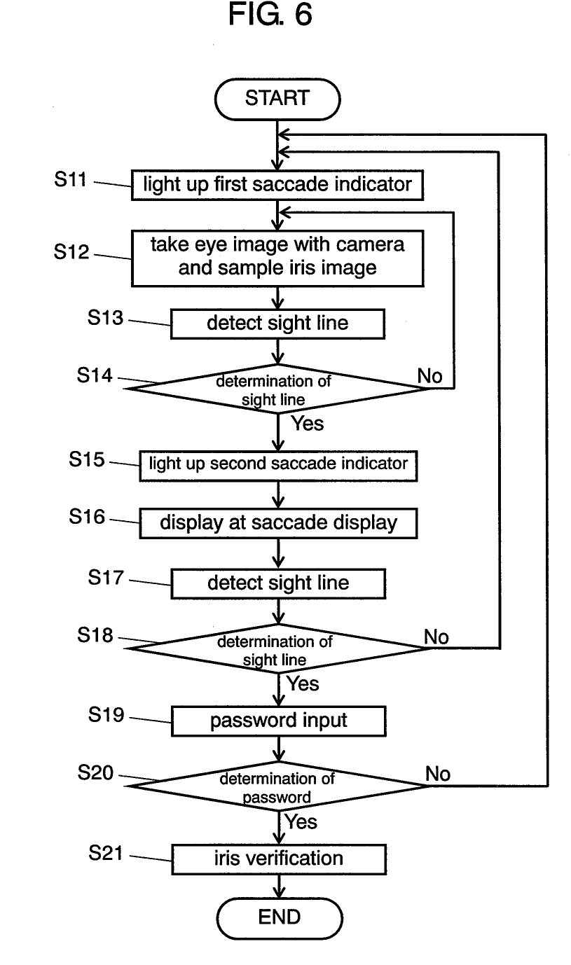

FIG. 5 is a timing chart indicating saccade display 50. First, saccade indicator 1 lights out at t0, and saccade indicator 2 lights up at t1. The eyeball points toward saccade indicator 2 by lighting up saccade indicator 2. However, the eyeball does not move immediately, and moves from t2 after a time lag called “latent time”. Saccade display 50 is preferably displayed between t3 to t4 when the eyeball moves at a constant speed. In general, because a saccade speed is 300-500°/s, when a sight-line-moving angle is 10°, it takes approximately 33 ms from t3 to t4. Lighting-out time is set to approximately 200 ms between t0 and t1 in order to stabilize the latent time. In the present embodiment, the latent time is expected to be approximately 200 ms.

The user, who has recognized the password with saccade display 50, can input the password by using password input means 60. The input password is verified at controller 180, and determined whether the user correctly recognize the password displayed at saccade display 50.

Verification section 190 verifies iris image information sent from iris image sampling section 174 and previously stored iris image information by using, for example, a method described in Japanese Translation of PCT Publication H8-504979, thereby performing iris verification operation.

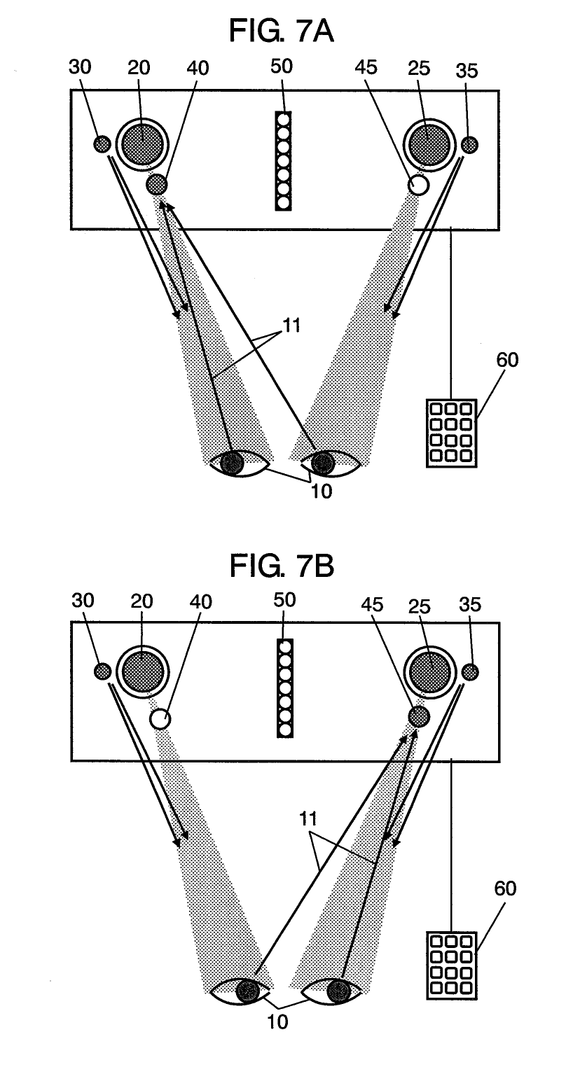

FIG. 6 is a flow chart showing operation of the iris verification device in accordance with the first exemplary embodiment of the present invention. First, fix sight line 11 of the user to camera 20 by lighting up first saccade indicator 40 (S11). Then, take the eye image of the user with camera 20, and sample the iris image among them with iris image sampling section 174 (S12). At the same time, detect sight line 11 of the user with sight line detecting section 173 (S13). Return to step S12 and take the eye image again when sight line 11 of the user does not point toward camera 20 (S14).

Next, light out first saccade indicator 40, and light up second saccade indicator 45. By this operation, the eyeball of the user moves from first saccade indicator 40 to second saccade indicator 45 (S15). At this time, display the password at saccade display 50 in such a manner as to show in FIGS. 4A through 4G and FIG. 5. After that, detect sight line 11 of the user with sight line detecting section 173 again (S17). At this time, in a case where sight line 11 of the user point toward camera 20, movement of the sight line in saccade does not occur, so that it may be impersonation or the like. Therefore, return to step S11 and restart from the beginning (S18).

Next, wait for input of the password through password input means 60 (S19). Then controller 180 determines whether the input password is correct or not. Return to step S11 and restart from the beginning if the password is not correct (S20). If the password is correct, the taken image is determined that it is not an iris image copied on a photograph or an artificial eye. Then, the iris image information sent from iris image sampling section 174 and the iris image information previously stored are verified by using verification section 190. If these verified information correspond to each other, verification is regarded as success. If these verified information do not correspond to each other, verification is regarded as failure (S21).

As discussed above, the first embodiment does not utilize conventional contractile response of the pupil. Instead, the first embodiment confirms biological reaction by detecting the movement of the eyeball and verifies the iris image which is suitable for personal verification. Therefore, accurate verification can be performed in an extremely short time, and unfair verification act such as impersonation can be prevented.

Existence or nonexistence of biological reaction in saccade can be confirmed only by detecting the sight line at steps S13, S14, and steps S17, S18. Accordingly, confirmatory operation of the password using saccade display 50 and password input means 60 may be omitted. In short, steps S16, S19 and S20 may be omitted.

### Second Exemplary Embodiment

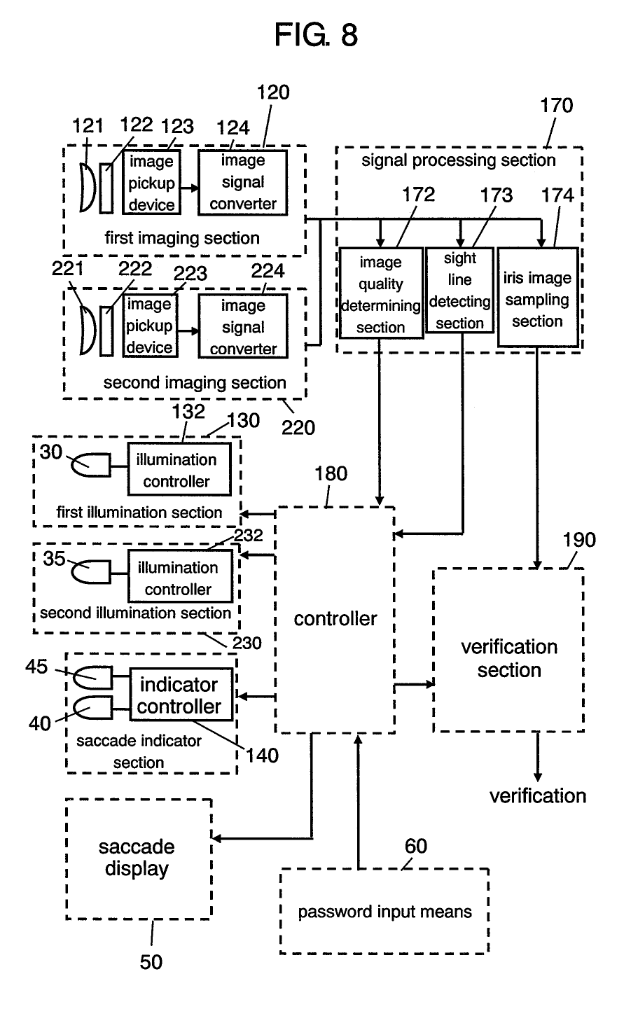

FIGS. 7A and 7B are schematic diagrams of iris verification devices in accordance with the second exemplary embodiment of the present invention. In FIGS. 7A and 7B, the elements similar to those demonstrated in the first embodiment have the same reference marks, and the descriptions thereof are omitted here. The second embodiment differs from the first embodiment in that second camera 25 and infrared emitting diode 35 are placed near second saccade indicator 45.

FIG. 7A shows a state where sight line 11 of a user is fixed to camera 20 by lighting up first saccade indicator 40, and FIG. 7B shows a state where sight line 11 has moved to second camera 25 by lighting up second saccade indicator 45.

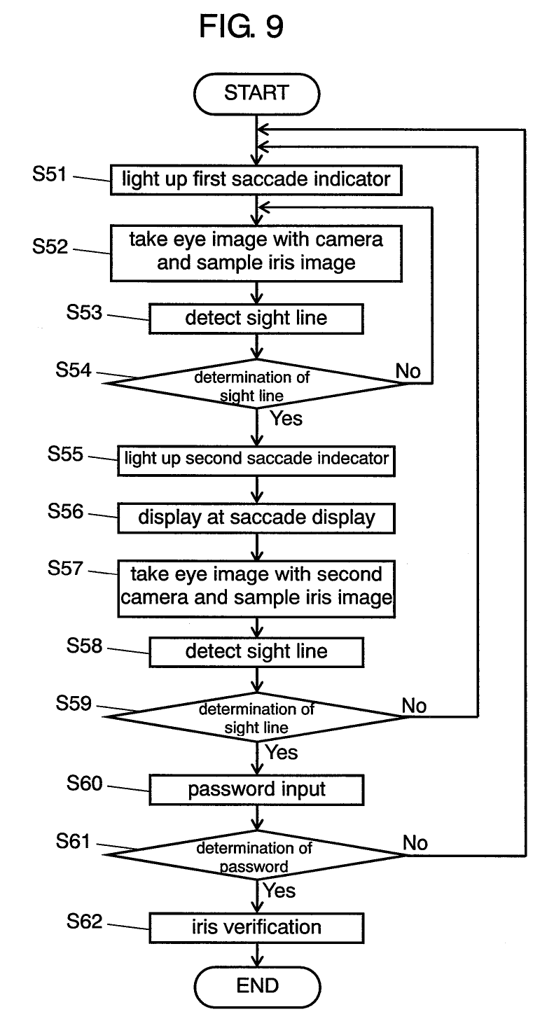

FIG. 8 is a circuit block diagram of an iris verification device in accordance with the second exemplary embodiment of the present invention. In FIG. 8 also, the elements similar to those demonstrated in the first embodiment have the same reference marks, and the descriptions thereof are omitted here. Second imaging section 220 as well as first imaging section 120 includes imaging lens 221 for forming an image of an eye, filter 222 for transmitting a wavelength within a certain range, image pickup device 223 formed of a CCD for converting transmitted light to an electric signal, and an image signal converter 224 for processing an electric signal output from image pickup device 223.

An image signal output from image signal converter 224 is sent to signal processing section 170. Signal processing section 170 includes image quality determination section 172 for determining contrast, brightness or the like, sight line detecting section 173 for detecting sight lines for first imaging section 120 and second imaging section 220, and iris image sampling section 174 for sampling iris images from the image signals obtained by first imaging section 120 and second imaging section 220.

Illumination section 230 is formed of infrared emitting diode 35 for emitting near-infrared light to illuminate eye 10 of the user and illumination controller 232 for controlling light amounts of infrared emitting diode 35.

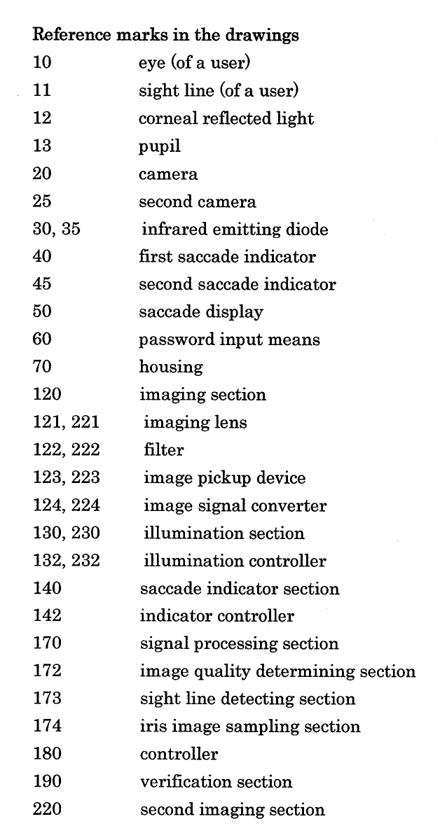

FIG. 9 is a flow chart showing operation of the iris verification device in accordance with the second exemplary embodiment of the present invention. First, fix sight line 11 of the user to camera 20 by lighting up first saccade indicator 40 (S51). Then, take an image of one eye (e.g., left eye) of the user with camera 20, at the same time, take an image of the other eye (e.g., right eye) of the user with second camera 25, and sample iris images from respective eye images with iris image sampling section 174 (S52). Meanwhile, detect sight line 11 of the user with sight line detecting section 173 (S53). Detect whether sight line 11 of the eye image taken with camera 20 points toward the camera or not, and return to step S52 and take the eye image again (S54) when sight line 11 of the eye image taken with second camera 25 points toward the camera. Proceed to the next step when sight line 11 of the user points toward camera 20 and does not point toward second camera 25.

Next, light out first saccade indicator 40, and light up second saccade indicator 45. By this operation, the eyeball of the user moves from first saccade indicator 40 to second saccade indicator 45 (S55). At this time, display a password at saccade display 50 in such a manner as to show in FIGS. 4A through 4G and FIG. 5. After that, take the image of one eye (e.g., left eye) of the user with camera 20, take the image of one eye (e.g., right eye) with second camera 25, and sample iris images from respective eye images with iris image sampling section 174 (S57). Meanwhile, sight line detecting section 173 detects sight lines of the user from the respective images (S58). In a case where the sight line of the user points toward camera 20 or the sight line of the user does not point toward camera 25, biological reaction caused by saccade is not generated. Thus, return to step S51 and take the eye image again (S59). Because passing speeds of the sight line are different among individuals, it is difficult to catch the image of the moment when sight line 11 of the user points toward second camera 25 by taking image at one time. Accordingly, it is preferable that second camera 25 takes the eye image repeatedly at timing after t3 shown in FIG. 5, and sight line detecting section 173 detects sight line 11 of the user based on whether the image that sight line 11 of the user points toward second camera 25 exists or not among the eye images.

Proceed to the next step when sight line 11 of the user does not point toward camera 20 and points toward second camera 25.

Wait for input of the password through password input means 60 (S60). Then, controller 180 determines whether the input password is correct or not. Return to step S51 and restart from the beginning (S61) if the password is not correct. Verify iris image information of both eyes sent from iris image sampling section 174 and previously stored iris image information of both eyes with verification section 190. If these verified information correspond to each other, verification is regarded as success. If these verified information do not correspond to each other, verification is regarded as failure (S62). Verification can be performed by using the steps discussed above. Because iris information can be verified by both eyes, more secure verification can be performed compared with the first embodiment.

In the second embodiment, to verify using iris information of both eyes, iris verification is performed by using the eye image of the right eye taken with camera 20 before saccade and the eye image of the left eye taken with second camera 25 after saccade. However, in order to confirm that saccade is generated at the same eye (e.g., right eye), iris verification may be performed by using the eye image of the right eye taken with camera 20 before saccade and the eye image of the right eye taken with second camera 25 after saccade. By using this kind of structure, generation of saccade can be detected by the same eye.

According to the first embodiment and the second embodiment, as shown in FIGS. 3A and 3B, a direction of the sight line is determined by detecting the difference between corneal reflected light 12 and the center position of pupil 13. However, a method for detecting flatness of the pupil may be used as the method for detecting sight line. In a word, if the shape of pupil 13 is close to a perfect circle as shown in FIG. 3A, it is determined that the sight line points toward camera 20. On the other hand, as shown in FIG. 3B, if pupil 13 is flattened more than a predetermined value, it is determined that the sight line does not point toward camera 20.

The iris verification device of the first embodiment and the second embodiment is intended to be set in a dark place or a dimly lit room. However, when it is used in the outside or in the inside under an environment where illumination is very strong and saccade is hard to be generated, it is preferable to cut off light by forming a hood or the like. Alternatively, if the whole device is enclosed by light-shielding walls and the user looks from an inspection window, the advantages that saccade display becomes easily viewable, password is not seen by others, or the like as well as saccade is easily generated can be obtained.

In addition, effects of preventing unfair verification act such as impersonation can be further heightened by performing processes shown in the flow chart of FIG. 6 or FIG. 9 more than once.

In the present embodiment, an angle of saccade or an interval between the saccade indicators is set to the value above described as one example, however the present invention is not limited to these designed values.

### INDUSTRIAL APPLICABILITY

An iris verification device of the present invention can perform both acquisition of an iris image suitable for personal verification and detection of biological reaction in a short time. Therefore, the iris verification device capable of preventing unfair verification act such as impersonation can be provided, so that it is useful for a system, a device or the like which needs personal verification.

1. An iris verification device comprising:
an imaging section for taking an image of an eye of a user;
a first saccade indicator for fixing a sight line of the user by lighting-up;
a second saccade indicator, which is placed apart from the first saccade indicator, for moving the sight line of the user by lighting-up;
a sight line detecting section for detecting the sight line of the user from the image taken at the imaging section;
an iris image sampling section for sampling an iris image from the image taken at the imaging section; and
a verification section for performing iris verification based on the iris image sampled at the iris image sampling section,
wherein the sight line detecting section detects movement of the sight line of the user, which is accompanied by the lighting-up of the second saccade indicator.

2. An iris verification device comprising:
a first imaging section for taking an image of an eye of a user;
a first saccade indicator, which is placed adjacent to the first imaging section, for fixing a sight line of the user;
a second imaging section, which is placed apart from the first imaging section, for taking an image of the eye of the user;
a second saccade indicator, which is placed adjacent to the second imaging section, for moving the sight line of the user;
a sight line detecting section for detecting the sight line of the user from the image taken at least at one of the first imaging section and the second imaging section;
an iris image sampling section for sampling an iris image from the image taken at least at one of the first imaging section and the second imaging section; and
a verification section for performing iris verification based on the iris image sampled at the iris image sampling section,
wherein the sight line detecting section detects movement of the sight line of the user, which is accompanied by lighting-out of the first saccade indicator and lighting-up of the second saccade indicator.

3. The iris verification device of claim 1 further comprising:
a saccade display, which is placed between the first saccade indicator and the second saccade indicator, for displaying a password;
a password input section for inputting the password displayed at the saccade display; and
a controller for determining whether the password input from the password input section is correct or not.

4. The iris verification device of claim 2 further comprising:
a saccade display, which is placed between the first saccade indicator and the second saccade indicator, for displaying a password;
a password input section for inputting the password displayed at the saccade display; and
a controller for determining whether the password input from the password input section is correct or not.
